(19) United States
(12) Patent Application Publication
(10) Pub. No.: US 2024/0160960 A1
(43) Pub. Date: May 16, 2024

(54) METHOD FOR THINNING A SLAM GRAPH, METHOD FOR OPERATING A MOBILE DEVICE, AND MOBILE DEVICE

(71) Applicant: Robert Bosch GmbH, Stuttgart (DE)

(72) Inventors: Gerhard Kurz, Karlsruhe (DE); Matthias Holoch, Leonberg (DE)

(21) Appl. No.: 18/550,944

(22) PCT Filed: Jul. 1, 2022
(86) PCT No.: PCT/EP2022/068245

§ 371 Date: Sep. 15, 2023

(30) Foreign Application Priority Data
Jul. 13, 2021 (DE) 10 2021 207 418.9

(51) Int. Cl. G06N 5/022

(52) U.S. Cl. CPC G06N 5/022

(57) ABSTRACT

A method for thinning a SLAM graph, which is used for operating a mobile device and has a multiplicity of nodes and a multiplicity of edges, each of which ends with an end point at a node. The SLAM graph is obtained, nodes are removed from the SLAM graph, and then an updated SLAM graph is output. Removing a node in each case includes determining, out of the multiplicity of nodes, the node whose scale-invariant density at further nodes around said node is the highest, and removing the determined node whose density is the highest from the SLAM graph.

### FIELD

The present invention relates to a method for thinning a SLAM graph that is used for operating a mobile device, for example a domestic robot, to a method for operating a mobile device, to an arithmetic logic unit and a computer program for carrying out the method, and to a mobile device.

### BACKGROUND INFORMATION

Mobile devices such as robot vacuum cleaners or robot mops or other domestic robots typically move in an environment in which work is to be performed, for example a home. One of the fundamental problems that such mobile devices and other mobile devices have to address is orienting themselves, i.e., knowing what the environment looks like and where they are located (in absolute terms). For this purpose, the mobile device is equipped, for example, with various sensors such as ultrasonic sensors, cameras or LiDAR sensors, using which the environment is captured in two or three dimensions, for example. This allows the mobile device to move locally and to detect obstacles in good time and go around them.

If the absolute position of the mobile device is also known, for example from additional GPS sensors, a map can be constructed. In this case, the mobile device measures the relative position of potential obstacles in relation to itself and can then use its known position to determine the absolute position of the obstacles, which are then entered into the map. However, this only works with position information that has been provided externally.

SLAM (simultaneous localization and mapping) refers to a method in robotics in which a mobile device such as a robot simultaneously can or has to create a map of its surroundings and estimate its pose within that map. It is thus used for detecting obstacles and therefore assists with autonomous navigation.

### SUMMARY

According to the present invention, a method for thinning a SLAM graph, a method for operating a mobile device, an arithmetic logic unit and a computer program for carrying out said method, and a mobile device are provided. Advantageous configurations and example embodiments of the present invention are disclosed herein.

The present invention is concerned with SLAM and its use in mobile devices. A typical example of a mobile device is a domestic robot such as a robot vacuum cleaner and/or a robot mop. However, SLAM is also used in other types of robots, and in drones and vehicles when they travel in an at least partly automated manner, for example. In SLAM there are in turn various approaches for depicting maps and positions. One approach, which is also used within the context of the present invention, is “graph-based SLAM”. In this, the map is depicted on the basis of a graph (also referred to hereinafter as a SLAM graph) which has a multiplicity of nodes and a multiplicity of edges, each edge generally connecting two nodes. The end points of the edge are thus positioned on the nodes. In principle, however, there may also be edges that are connected to just one node or even those that are connected to more than two nodes. As soon as such a graph is created, the map can be calculated by finding the spatial configuration of the nodes that largely correlates with the measurements modeled by the edges.

In this case, the nodes each correspond to a pose (position and orientation) of the mobile device, and the edges correspond to connections therebetween. There are various types of edges in this regard. An edge can be obtained from observations of the environment, for example by determining the direction in which an identified obstacle is located. However, an edge can also be obtained from an (actual) movement of the mobile device, e.g., by odometry. After a particular route has been covered by the mobile device, a new node can then be added, for example, and environment information is captured and stored at the same time. An edge of this kind will also be referred to below as a movement edge. If, after having been in a previously unknown environment for a relatively long time, the mobile device arrives back in a known environment (in which environment information has already been captured), attempts can be made to link (“match”) the older environment information to the current environment information on the same environment. In this case, there are two nodes or locations at which environment information is captured. If the linking (or fitting) is successful, an edge can be formed between said two nodes. An edge of this kind is also referred to below as a loop-closure edge, since it closes a loop, as it were.

In this case, the mobile device is operated such that environment information is obtained, for example by a controller of the mobile device, said environment information being captured in particular using one or more sensors, for example video cameras, radar sensors, LiDAR sensors, laser rangefinders, ultrasonic sensors, inertial sensors, and/or odometers. This environment information thus includes, for example, video or camera data, distance information regarding obstacles, or routes traveled. On the basis of this environment information and a current SLAM graph or a corresponding map, and by applying a suitable SLAM algorithm, for example, a current pose or position and/or orientation of the mobile device is determined.

On that basis, control instructions for operating the mobile device can then be determined or generated, and these can then be implemented by the mobile device, or first can be transmitted thereto (if the calculations are carried out outside the mobile device, for example on a computing system external to the device, e.g., in a cloud). The control instructions can be determined, for example, as part of a control algorithm. This is repeated again and again, for example every 50 cm. In this way, the mobile device can, for example, carry out its work, such as vacuuming, but also can keep improving the map.

However, constantly adding nodes and edges to the SLAM graph makes the SLAM graph larger and larger, i.e., the data volume becomes greater and all the calculations based on the SLAM graph require more computing power and/or time.

One solution to this problem is to thin the SLAM graph, i.e., to remove nodes and/or edges therefrom, thus reducing the data volume. Yet this leads to a different problem: the accuracy of the map depicted by the SLAM graph may sometimes be significantly reduced or the information content thereof may be diminished. Against this background, an option is provided according to the present invention for thinning a SLAM graph in such a way that the size thereof is reduced but the accuracy is retained as far as possible.

For this purpose, according to an example embodiment of the present invention, the SLAM graph is obtained (for example as a dataset which thus includes the nodes and edges and possibly other information), for example directly in an arithmetic logic unit or a controller of the mobile device or also in an external arithmetic logic unit. Nodes are then removed from the SLAM graph so as to obtain an updated SLAM graph (i.e., an updated dataset), which is output, for example to a corresponding unit in the mobile device or in the controller therein. In each case, removing a node comprises determining, out of the multiplicity of nodes, the node whose scale-invariant density at further nodes around said node is the highest, and then removing the thus determined node whose density is the highest from the SLAM graph.

To limit the quantity of nodes within the SLAM graph, it is generally necessary to remove the nodes diligently over time. Generally, at least two strategies are possible for this purpose. One strategy is to select and remove one or more nodes (also referred to as marginalization). Another strategy is to select two or more nodes and to fuse them into one. In the case of SLAM based on LiDAR sensors, the second strategy has the drawback, for example, that the LiDAR scans (environment information) have to be merged and the position of the new node does not match the position at which the LiDAR scans were originally taken. It is thus no longer possible to easily track LiDAR beams (which led to the environment information) in the room, which is important for some algorithms. In addition, all the further information that can be linked to the involved nodes likewise has to be merged. Lastly, the merged node is not necessarily part of the original trajectory and could, for example, be located in an impassable area (e.g., in an obstacle). For these reasons, it is expedient to use the first strategy.

In that case, the nodes for removal then need to be determined. Generally, simultaneously removing a plurality of nodes could be considered, and a combined effect of this operation could be analyzed. However, this is difficult to analyze, so it is preferable to remove individual nodes. A node selected for removal should be a node that has little bearing on the overall imaging quality (i.e., on the quality of the depiction of the map by the SLAM graph) and whose removal impairs the future performance of the SLAM algorithm as little as possible. To quantify the significance of a node, geometric or information-theory measures can be used.

Information-theory measures attempt to quantify the information included in each node or the information from the associated laser scan (or generally the captured environment information). It is advantageous to remove the node in such a way as to minimize the information loss. The main problem with this approach, however, is that the actual information within a scan is difficult to quantify. The information can be calculated on the basis of the probability of cells in a probabilistic grid map being occupied. It has been found, however, that this approach tends to regard scans with high noise levels, false measurements, or poor orientation as highly informative, since they influence the probabilities within the grid map more significantly than well-oriented scans that have low noise levels and that correlate closely with other scans of the environment. In addition, calculating the information is highly complex since all the points in scans within the area of the current node influence the result. This can cause problems in particular in the case of long-range, high-resolution LiDAR sensors.

According to an example embodiment of the present invention, preferably, therefore, geometric methods are used for removing nodes. The basic idea is to observe the density of the nodes and, in particular, keep it below a particular threshold over the entire map; in other words, nodes are removed at locations (in the environment) at which many nodes are pooled in a small area. For this purpose, a novel density measure is proposed, which will be referred to below as the scale-invariant density.

A density for a node can be defined as a quantity of further nodes within a particular area around said node, for example within a particular radius around said node.

For v₁, . . . , vₙ ∈ [symbol] ², where vᵢ≠vⱼ for i≠j, for a radius r>0 such a density for a node vᵢ can be defined as follows:

$${d}_{r} ( {v}_{i} ) = \frac{\# \{ ‖ {v}_{j} - {v}_{i} ‖ < r : 1 \leq j \leq n , i \neq j \}}{{πr}^{2}}$$

where ||.|| indicates the Euclidean norm. This thus corresponds to the quantity (#) of nodes within a circle of radius r around the node vᵢ but without said node itself.

However, this density is highly dependent on the selected value for the radius; for example, there could be a large quantity of further nodes just outside the selected radius. The actual density for this node would therefore be highly underdetermined.

This is addressed via a scale-invariant density. By way of example, for a node this indicates a measure of simple densities (as above) determined over various radii. This can be done, for example, by integrating the above-mentioned (simple) density over all r. The scale-invariant density d(vᵢ) for the node vᵢ is then generated by:

$$d ( {v}_{i} ) = {\int }_{- ∞}^{∞} {d}_{r} ( {v}_{i} ) dr$$

This scale-invariant density no longer depends on the selection of a particular value for the radius, thus avoiding any false determinations of densities for nodes. In a sense, the integral constitutes an average over a high or infinite number of possible radii. Moreover, it can be seen that (at least for the present requirements) this depiction is equivalent to the following depiction:

$$d ( {v}_{i} ) = \frac{1}{π} {\sum }_{k = 1}^{n - 1} {r}_{k}^{- 1}$$

The scale-invariant density can thus be calculated considerably more quickly and simply. In addition, this collective depiction can be truncated to, for example, a particular quantity of further nodes most closely adjacent to a determined node.

According to an example embodiment of the present invention, preferably in this case, as many nodes are removed in this way as are needed until the scale-invariant density is below a particular threshold—a density threshold—at all the nodes. Alternatively or additionally, it is preferable if as many nodes are removed as are needed until a quantity of nodes in the SLAM graph is below a particular threshold—a node threshold. In this case, however, it is expedient if the node threshold is predetermined on the basis of a geometric size of an environment represented by the SLAM graph, i.e., is proportional thereto. Thus, when the surface area of the environment is twice as large, the desired quantity of remaining nodes can be doubled too. In that case, the average density of nodes does not depend on the size of the environment. However, it is also possible for the two variants to be combined, i.e., for it to be necessary for both thresholds to be undershot.

According to an example embodiment of the present invention, it is also advantageous if a predetermined quantity of nodes most recently added to the SLAM graph are not taken into account when removing nodes. These nodes are then disregarded, for example as early as when determining the node having the highest scale-invariant density, and then accordingly are not removed either. However, said most recently added nodes should be taken into account when determining the scale-invariant density for other nodes, otherwise the desired maximum total quantity of nodes would not be reached, for example. In this way, the robustness of the method can be increased.

When a node is removed, the edges that ended at the removed node are no longer defined. In essence, the graph encodes a collective probability distribution of random variables represented by all the nodes. Thus, removing a node corresponds to the marginalization or the removal of a random variable. Preferably, therefore, removing a node from the SLAM graph additionally comprises in each case linking those end points of edges which were defined by the removed node to another node. In other words, the nodes that were connected to the removed node via edges are thus reconnected.

To solve this problem, an “n-ary constraint” can be defined between all the nodes adjacent to the removed node. These adjacent nodes could then, for example, be connected in pairs to edges (the previous edges would then be removed), although this leads to a high quantity of edges and is undesirable if the data volume is to be reduced. It has been found that one problem when handling the edges of the removed node is that, in doing so, false loop-closure edges may be produced, which are thus unrelated to the reality and the actual movement of the mobile device. While many algorithms can cope with a small quantity of such false loop-closure edges, having too many of them is difficult to handle. It has been found that there is also a problem in that when such false loop-closure edges are evaluated by an algorithm for the information content, they do not have a greater level of uncertainty than genuine loop-closure edges.

If, in the above example with the paired connection of the adjacent nodes, one of n edges of the removed node was false, for example, the paired connection produces n·(n−1)/2 new edges, of which n−1 are false. The ratio of false edges to genuine edges is thus increased from 1/n to 2/n. If a (genuine) edge was already present where a new edge is generated between two adjacent nodes, said (genuine) edge would be replaced or merged with a new edge, leading to an even poorer ratio.

It has been found that edges produced by moving the mobile device—the aforementioned movement edges—are considerably more reliable or more accurate than loop-closure edges, even when the two edges have the same level of uncertainty. Whereas, for example, the odometry for movement edges can drift slightly over time, such edges, by contrast with loop-closure edges, are generally not influenced by outliers having a large error.

Against this background, it is preferable, when handling the edges that end at a removed node, to take account of movement edges (which are more reliable) or a movement chain (i.e., a chain of movement edges) rather than loop-closure edges or loop closures.

One option would also be to select one such adjacent node and to connect to said selected nodes all the edges (or end points of the edges) that ended at the removed node. In this case, a total of the length of the edges thus produced or altered could be minimized, for example. In this context, however, the reliability of movement edges or movement chains would not be taken into account. By contrast, as mentioned, the edges that ended at the removed node are each also linked to another node, such that they end there, but not all (or at least not necessarily all) to the same node.

Instead, out of the nodes adjacent to the removed node, the node at which an edge is now supposed to end is preferably selected by moving the unconnected end point of the edge forward or backward along a movement chain until another node is reached. The movement chain indicates the (chronological) sequence of nodes along which the mobile device has moved. For each node, therefore, there is a chronologically previously generated node and a chronologically subsequently generated node on the movement chain. Thus, starting from the removed node, the chronologically previously generated node and the chronologically subsequently generated node, for example, are searched for and the unconnected end point of the edge is linked to one of the two nodes. Expediently, out of the two nodes, the node at which the resulting edge is the shortest is selected, in other words the node at which the length is the shortest, i.e., is shorter than in other theoretically possible edges. This takes account of the reliable movement edges or movement chains. In this approach, too, there are two edges which themselves are part of the movement chain (i.e., they are movement edges). These two edges are replaced by a new edge between their remaining nodes.

This approach, i.e., the linking of end points of edges to new nodes, is ultimately the concatenation of edges. There are typically three different options for this. Two edges can be linked, they can be combined, and one edge can be inverted. By way of example, two edges (one from node a to node b and one from node b to node c) are linked by generating a new edge from node a to node c instead of the two previous edges. Node b is the removed node in this case. This can be done with the two edges that are part of the movement chain, as mentioned above. When two edges are combined, the constraints thereon are, for example, combined by multiplying their two Gaussian distributions. Each edge has a particular uncertainty, which can be or is modeled, for example, using a Gaussian distribution. In this case, the Gaussian distribution describes the probability distribution of the edge error. In this case, the error is generally the difference between the relative pose stored in the edge and the relative pose of the nodes that the edge connects. An edge can be inverted using a Lie algebra, for example.

More information on these three options and their application can be found, for example, in E. Eade, P. Fong, and M. E. Munich, “Monocular graph SLAM with complexity reduction”, in Proc. IEEE/RSJ Int. Conf. Intelligent Robots and Systems, 2010, pp. 3017-3024. In this approach, the quantity of false loop-closure edges is substantially not changed since no loop-closure edges are newly generated or erased; instead, only the one node of the edge is changed. However, combining edges may result in a plurality of edges coinciding. In the above example, the quantity of edges is reduced from n to n-1, but the ratio of false edges to genuine edges is then increased from 1/n to 1/(n−1), i.e., is only increased slightly, but is not doubled.

When two edges are combined, they may end up contradicting one another. This can be determined or identified by, for example, observing the relative pose for the two edges (a relative pose of an edge corresponds to a difference in the poses of the nodes at the end points of the edge) or by a Mahalanobis distance. If one of the two edges is a loop-closure edge and one is a movement edge, the loop-closure edge is removed. If both edges are loop-closure edges, both are removed. This is advantageous in that it is generally better to lose one genuine or correct loop-closure edge than to generate one false loop-closure edge.

Although associated edges can also be removed from the SLAM graph when nodes are removed, it is preferable to remove edges from the SLAM graph independently of any removal of a node. This is expedient in particular in areas in which the nodes are not especially closely distributed. In addition, when removing nodes, it is possible that new edges are generated, which can be removed in this way. In principle, edges can thus be removed even without any removal of nodes (either because this is not even applied or because, for example, the density is not over the threshold anywhere), as a result of which the size of the SLAM graph or its data volume can be reduced, especially since the information contained in the edges is removed.

Removing an edge in each case comprises determining, out of the multiplicity of nodes, the node at which the most edges end; edges can thus be removed where the density thereof is high. The edge to be removed can then be selected from the edges ending at said node on the basis of a criterion. One option is to remove the edge having the lowest residuum or the lowest chi-square error. In that case, however, edges having a large error would be retained, and these are mostly edges having either high noise levels or false loop-closure edges. A large error may mean that the edge is false, but it can also mean that the current optimum of the graph optimization deviates considerably from the true optimum. If the edge is then removed, information by which the “true” optimum could have been found may then be lost.

By contrast, according to an example embodiment of the present invention, it is expedient if, out of the edges that end at the determined node, the edge that has the greatest covariance or the least amount of information is determined; the edge determined in this way, i.e., the edge having the greatest covariance or least amount of information, is then removed. The covariance or information of an edge, or a measure thereof, can be determined, for example, on the basis of the trace or the determinant of the associated matrix (covariance matrix or information matrix) of the edge. In this case, using the information is preferable owing to the slightly simpler calculation.

Expediently, according to an example embodiment of the present invention, independently of any removal of a node, (only) as many nodes are removed from the SLAM graph as are needed until a quantity of edges that end at the same node is below a threshold—an “edge threshold”—at all the nodes. In this way, the quantity of edges removed is not excessive, and a uniform distribution is obtained.

In principle, removing edges brings the risk that edges that are important for the SLAM graph or the map are also removed, for example those that are important global loop-closure edges; the entire SLAM graph could even be broken open. In this respect, it is expedient if an edge is removed (in particular when removing edges independently of node removal) only when a factor, which indicates a ratio of a length of a shortest path, not containing the edge, between the two nodes at which the edge ends to a length of the edge, is below a threshold—a “factor threshold”. Whereas an edge indicates the shortest connection (a path) between two nodes (the length of the edge), after the edge is removed a longer course, leading for example via one or more further nodes and corresponding edges, is inevitably produced for a path between said two nodes. If this new path is then much longer than the removed edge, this points to the fact that the removed edge is an important edge or connection. Against this background, such a factor threshold (which is inevitably greater than one and can, for example, be between two and five) can be introduced, but it should not be selected to be too large.

Regardless of this, it is preferable if an edge is removed (in particular when removing edges independently of node removal) only when it is a loop-closure edge. Thus, in principle the movement edges are not removed; as mentioned above, they are generally very reliable. In particular, the movement edges are counted when determining the quantity of edges per node but are not removed.

Overall, using the proposed approach according to the present invention, a SLAM graph can be thinned particularly quickly and efficiently, such that the size (data volume) thereof does not become too great. For example, the thinning can be carried out regularly, e.g., after each new addition of environment information at a location (node) or even after a plurality of additions. The size of the SLAM graph or its data volume thus remains substantially constant, regardless of the time period over which data are added to the SLAM graph. This allows for a lifelong SLAM. Whereas the rate at which a SLAM algorithm processes such a SLAM graph remains high, the accuracy of the SLAM graph or of the corresponding map is barely reduced.

The present invention further relates to the operation of a mobile device, in particular a robot, wherein environment information captured in particular using one or more sensors is obtained, and a current position and/or orientation (e.g., pose) of the mobile device is determined on the basis of a current SLAM graph (or corresponding data representing said SLAM graph) or a corresponding map and the environment information, e.g., by applying a suitable SLAM algorithm. Then, control instructions for operating the mobile device are determined on the basis of the current position and/or orientation and are implemented by the mobile device.

In this case, an older SLAM graph that has been thinned or updated in accordance with the above approach can then be used as the current SLAM graph, e.g., after environment information has been obtained beforehand. Likewise, the current SLAM graph can then also be expanded using the environment information and can then be thinned in accordance with the above approach, namely for later use as a current SLAM graph.

An arithmetic logic unit according to the present invention, for example a controller of a robot, is configured, in particular programmed, to carry out a method according to the present invention.

The present invention further relates to a mobile device comprising such an arithmetic logic unit (e.g., as a controller) and one or more of the sensors mentioned at the outset. The mobile device is preferably configured as a robot, in particular a domestic robot, for example a robot vacuum cleaner and/or a robot mop, a floor or street cleaning device or a robot lawnmower, as an at least partly automated vehicle, or as a drone.

Implementing a method according to the present invention in the form of a computer program or computer program product comprising program code for carrying out all the method steps is also advantageous since this leads to particularly low costs, in particular if an executing controller is also used for other tasks and is therefore provided anyway. Lastly, a machine-readable storage medium is provided, comprising a computer program as described above stored thereon. Suitable storage media or data media for providing the computer program are, in particular, magnetic, optical, and electrical memories, for example hard disks, Flash memories, EEPROMs, DVDs, etc. Downloading a program via computer networks (internet, intranet, etc.) is also possible. Any such download can be performed in a wired or wireless manner (e.g., via a WLAN network, a 3G, 4G, 5G, or 6G connection, etc.).

Further advantages and configurations of the present invention become apparent from the description and the figures.

The present invention is shown schematically in the figures on the basis of an exemplary embodiment and will be described below with reference to the figures.

### BRIEF DESCRIPTION OF THE DRAWINGS

FIG. 1A schematically shows a mobile device according to the present invention in a preferred specific embodiment of the present invention in an environment.

FIG. 1B schematically shows a sequence of a method according to the present invention in a further preferred specific embodiment.

FIG. 1C schematically shows a sequence of a method according to the present invention in a further preferred specific embodiment.

FIGS. 2A and 2B show an environment comprising a SLAM graph without and with thinning in accordance with a method according to the present invention in a preferred specific embodiment.

FIGS. 3A to 3C show an environment comprising a SLAM graph without thinning, with thinning not according to the present invention, and with thinning in accordance with a method according to the present invention in a preferred specific embodiment.

FIGS. 4A, 4B, 5A, and 5B show durations of scans and a quantity of nodes in different environments when a method according to the present invention in a preferred specific embodiment is applied.

### DETAILED DESCRIPTION OF EXAMPLE EMBODIMENTS

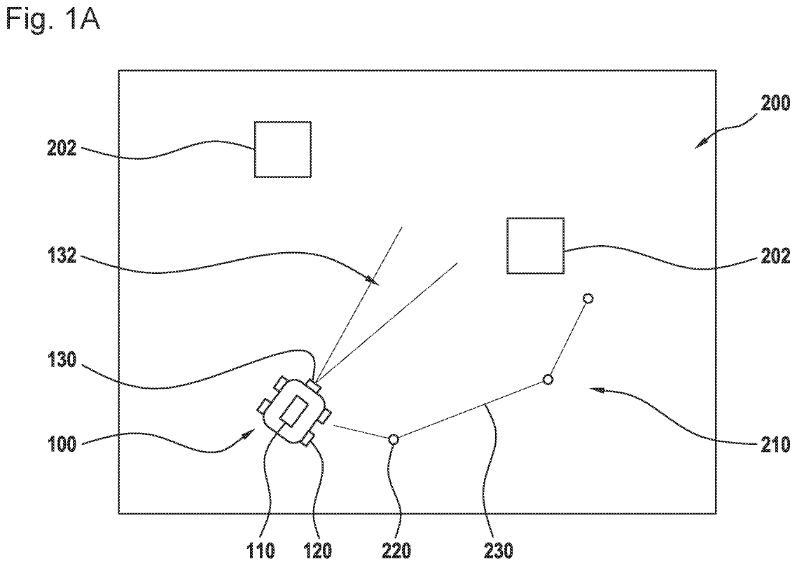

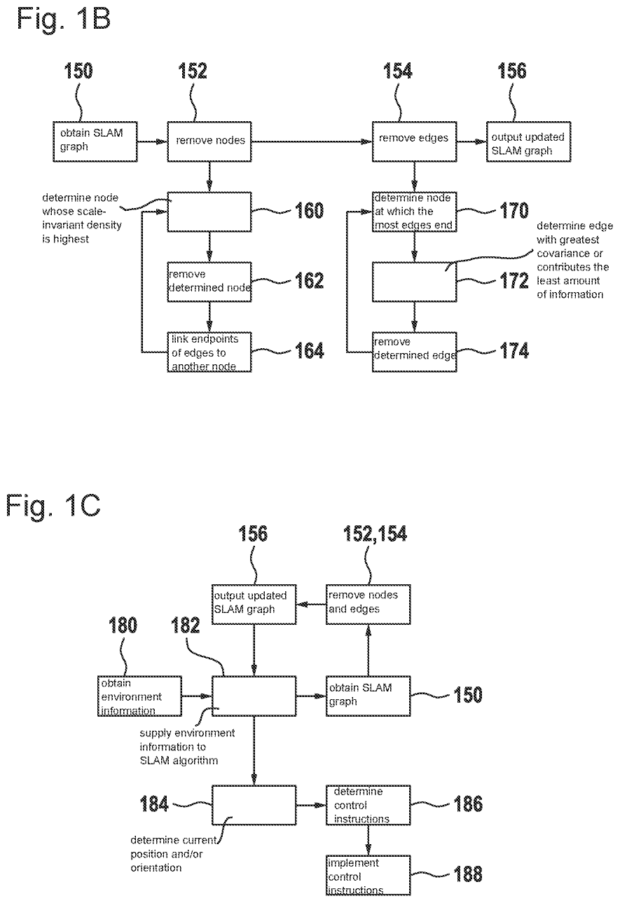

FIG. 1A schematically shows a mobile device 100 according to the present invention in a preferred specific embodiment in an environment 200, e.g., a room. By way of example, the mobile device 100 can be a robot vacuum cleaner comprising wheels 120, an arithmetic logic unit 110 configured as a controller, and a LiDAR sensor 130 having a field of vision 132. For illustration purposes, the field of vision 132 is selected to be relatively small in this case; in practice, however, the field of vision may also be up to 360° (but, for example, at least 180° or at least 270°. When it is 360°, the proposed method is particularly effective. The robot vacuum cleaner 100 is located on a floor of the room 200, which is delimited for example by walls and has two obstacles 202.

Also shown by way of example is a SLAM graph 210 having several nodes 220 and edges 230, which each connect two nodes. Each node 220 represents a location at which the robot vacuum cleaner captures environment information, for example using the LiDAR sensor 130, and the associated pose. In this case, the edges 230 represent movement edges, which are produced by traveling along the course between two nodes and are captured, for example, using odometry.

FIG. 1B schematically shows a sequence of a method according to the present invention in a further preferred specific embodiment, namely for thinning a SLAM graph that is used for operating the mobile device. In this case, in a step 150 the SLAM graph is obtained, e.g., as a dataset. It comprises the nodes having poses and associated environment information, and the edges between the nodes. The edges can also already include loop-closure edges in addition to movement edges.

In a step 152, nodes are then removed from the SLAM graph. Afterwards, in a step 154, edges could be removed from the SLAM graph, independently of the node removal.

Next, in a step 156 an updated SLAM graph is output, e.g., again as a dataset. By contrast with the previously obtained SLAM graph, this updated SLAM graph then lacks the removed nodes and the removed edges, and several other or new edges, as may be produced when nodes are removed, are added where applicable. The updated SLAM graph obtained in this way can then be used for operating the mobile device, as will be explained in more detail later in relation to FIG. 1C. By way of example, the thinning can be carried out in an external arithmetic logic unit, such that the SLAM graph is obtained therein from the mobile device and then sent back to said mobile device in updated form. Likewise, however, this can also be done in an internal arithmetic logic unit, e.g., a control unit of the mobile device. In that case, the graph is obtained, for example, by an internal storage unit, or sent thereto.

Step 152—node removal—can comprise the removal of one or more nodes. In turn, removing a node in each case also comprises a plurality of steps. In a step 160, first, out of all the nodes, the node whose scale-invariant density at further nodes around said node is the highest is determined. According to step 162, said node determined in the process is then removed from the SLAM graph.

Once the node has been removed, in a step 164 the now unconnected end points of loop-closure edges that ended at the removed node are each linked to another node. In this case, the new node for each end point is selected in each case by moving the unconnected end point forward or backward along a movement chain, the node being selected on the basis of the length of the newly produced edge. As mentioned, the two movement edges that were defined by the removed node can, for example, be combined. For instance, out of two movement edges from a to b and from b to c, one edge from a to c is then produced.

Steps 160, 162, and 164 are repeated for as long as it takes until the scale-invariant density is below a density threshold at all the nodes, i.e., nodes are removed from the SLAM graph until this is the case or as many nodes are removed as needed until this is the case. This can be established, for example, in step 160 by determining the node having the highest scale-invariant density. Likewise, this can be repeated, in the manner of an abort criterion, until the (total) quantity of nodes in the SLAM graph is below a node threshold, the node threshold being predetermined on the basis of a geometric size of the environment represented by the SLAM graph.

To remove an edge, step 154—removing edges from the SLAM graph independently of the node removal—first comprises, in step 170, determining, out of the multiplicity of nodes, the node at which the most edges end. In step 172, from these edges, the edge that has the greatest covariance or contributes the least amount of information to the graph is then determined. This edge is then removed in step 174. In particular, this can be done only when said edge is a loop-closure edge.

Steps 170, 172, and 174 are repeated for as long as it takes until the quantity of edges that delimit a node is below an edge threshold at all the nodes, i.e., edges are removed from the SLAM graph until this is the case or as many edges are removed as needed until this is the case.

FIG. 1C schematically shows a sequence of a method according to the present invention in a further preferred specific embodiment, namely the operation of the mobile device. For this purpose, first, in step 180, environment information is obtained, which is captured using one or more sensors, e.g., using the LiDAR sensor according to FIG. 1A. The environment information is thus sensor data.

In step 182, this environment information is then supplied to a SLAM algorithm in order to determine, in step 184, a current position and/or orientation of the mobile device on the basis of a current SLAM graph or corresponding data and the environment information, taking into account current odometry information.

In step 186, control instructions for operating the mobile device, i.e., whether the robot vacuum cleaner should turn and, if so, by how much and at what rate, and how far it should travel, are then determined on the basis of the current position and/or orientation. In step 188, these control instructions are implemented by the mobile device.

As mentioned, in step 182, environment information is fed to a SLAM algorithm. In this case, a current SLAM graph can be expanded using said environment information; in other words, a new node and a new edge are added, for example. As in relation to FIG. 1B, these data representing said expanded SLAM graph are fed by step 150 to an executing arithmetic logic unit, for example, where they are received and then thinned by steps 152, 154, including steps 160, 162, 164 and 170, 172, 174. In step 156, the thus updated data are fed back to the SLAM algorithm for the next use.

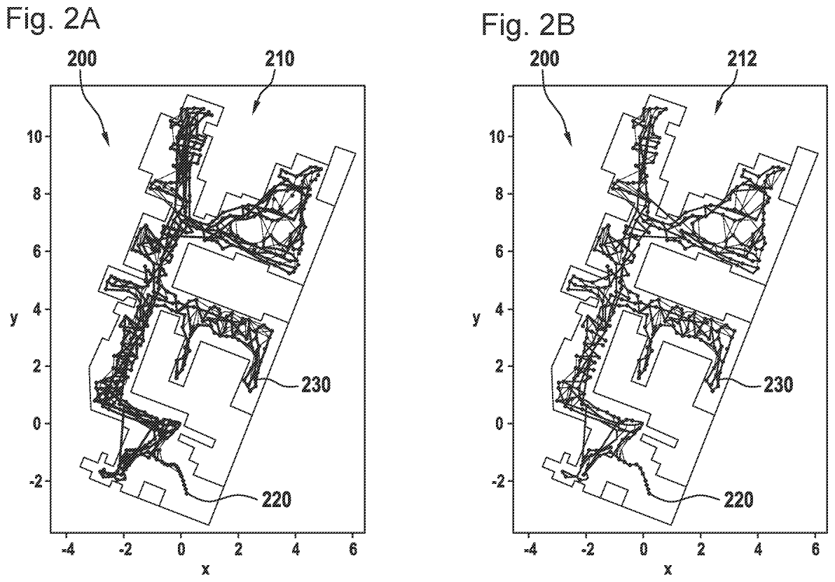

FIGS. 2A and 2B each show an environment 200 (similarly to FIG. 1A), but in each case with a significantly more detailed SLAM graph having nodes 220 and edges 230. FIG. 2A shows a SLAM graph 210, as obtained, for example, during the operation of a mobile device without thinning over time, i.e., when new nodes and edges are constantly added without any being removed.

By contrast, FIG. 2B shows, for the same (realistic) environment, a thinned SLAM graph 212 in which nodes and edges have been removed from the SLAM graph 210 in accordance with a method according to the present invention in a preferred specific embodiment, e.g., as described above. It is clear to see that the density of nodes is reduced and that the nodes are in particular distributed very uniformly.

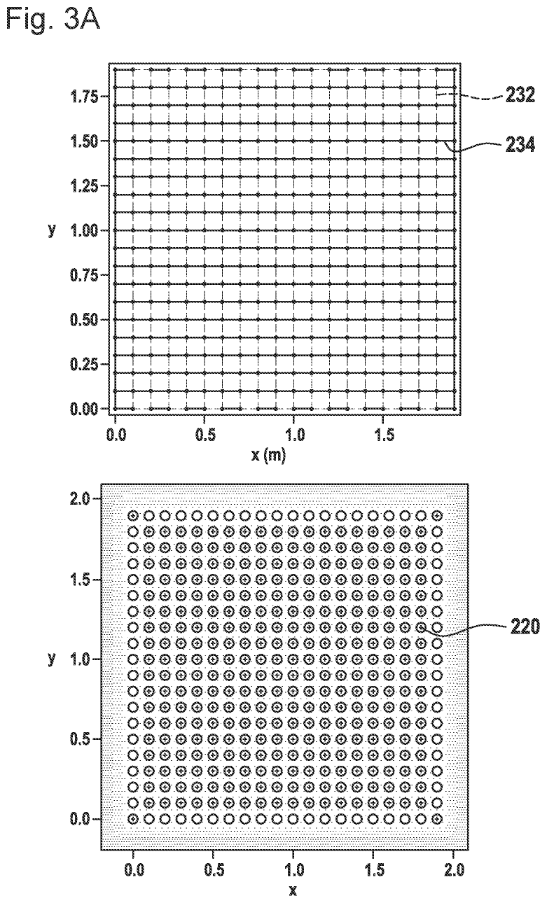

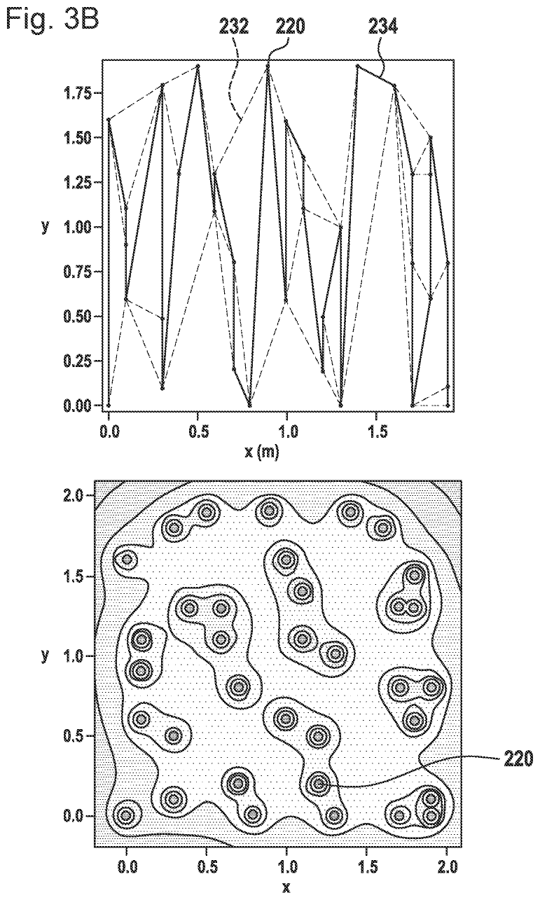

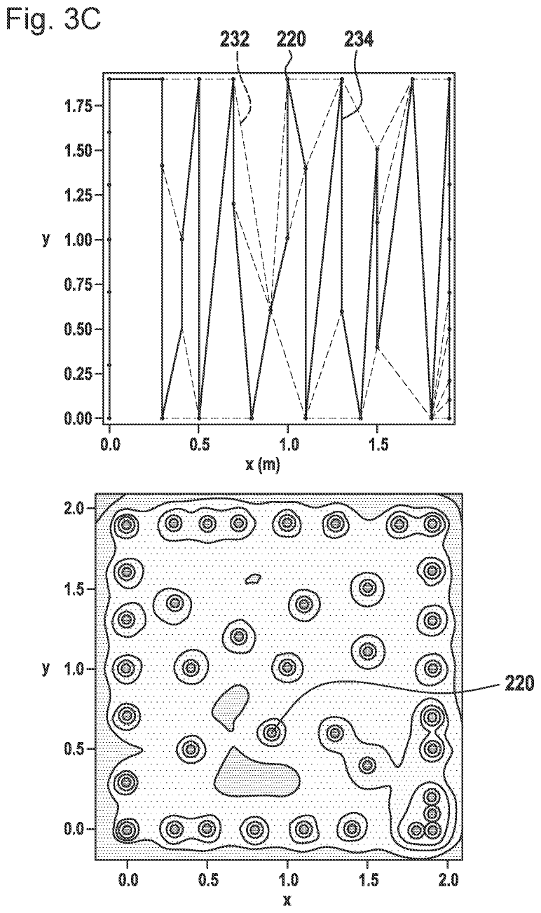

FIG. 3A to 3C each show an environment comprising a SLAM graph without thinning (FIG. 3A), with thinning not according to the present invention (FIG. 3B), and with thinning in accordance with a method according to the present invention in a preferred specific embodiment (FIG. 3C).

By way of example and to aid explanation (see FIG. 3A in this respect), the environment is a grid having regularly arranged nodes (in the form of a matrix), the edges each connecting two adjacent nodes vertically and horizontally. In the present case, the movement edges 234 extend in a meandering manner with long vertical straight lines. The additional horizontal edges 232 are loop-closure edges.

The top illustration shows the nodes and edges whereas the bottom illustration shows only the nodes with the density indicated. Initially, said density is relatively uniform but also very high (except at the edges).

FIG. 3B then shows nodes 220 and edges 232, 234 when the nodes to be removed are determined, for example, on the basis of a simple density (with fixed radius). It can be seen that the nodes remaining after removal are relatively irregularly distributed.

FIG. 3C then shows nodes 220 and edges 232, 234 when the nodes to be removed are determined on the basis of the scale-invariant density proposed within the context of the present invention. It can be seen that the nodes remaining after removal are distributed considerably more uniformly than is the case in FIG. 3B, for example. This shows that using the scale-invariant density yields a much more accurate SLAM graph.

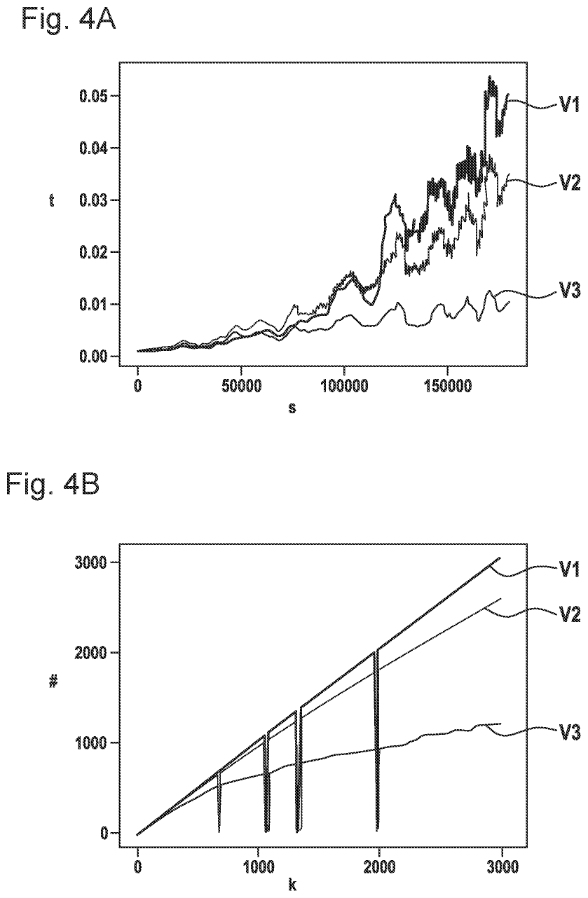

FIGS. 4A and 4B show durations t of scans plotted against the number s of the scan, and the quantity # of nodes plotted against the number k of a recording operation of a scan in a particular environment. Scans are typically carried out at a particular frequency, e.g., 10 Hz. Each of these scans is included in FIG. 4A. In this case, a scan comprises capturing environment information, for example using LiDAR sensors, the shown duration, and the processing of said environment information, including entering nodes and optimizing the SLAM graph.

However, generally not all of these scans are also used to enter a node or a piece of information into the SLAM graph; this is done, for example, only at certain time or spatial intervals. Therefore, the quantity of numbers k in FIG. 4B is lower than the quantity of numbers s in FIG. 4A. The quantity # of nodes plotted against the number k of a recording operation already incorporates the fact that nodes are also removed again (this can be done, for example, between two recording operations). This is shown with the application of a method according to the present invention in preferred specific embodiments (V2, V3) for operating a device including thinning the SLAM graph, by comparison with a reference (V1).

In this case, the lines V1 show the reference, in the case of which no thinning is carried out, the lines V2 show the application of a method according to the present invention in a preferred specific embodiment in which nodes and edges are removed relatively sparsely or sparingly, and the lines V3 show the application of a method according to the present invention in a preferred specific embodiment in which nodes and edges are removed to a relatively great or aggressive extent.

In this case, FIG. 4A shows that the time needed for a scan rises progressively in the case of the reference whereas, when the present invention is applied, the rise is considerably less, in particular when many nodes and edges are removed.

The quantity of nodes in FIG. 4B increases linearly in the case of the reference, but when the present invention is applied it increases considerably less, in particular when many nodes and edges are removed, and in particular also slowly becomes saturated.

It should be noted that the irregularities in the lines (zero points) are caused by a relocation after a new map run, so they have no impact in practice.

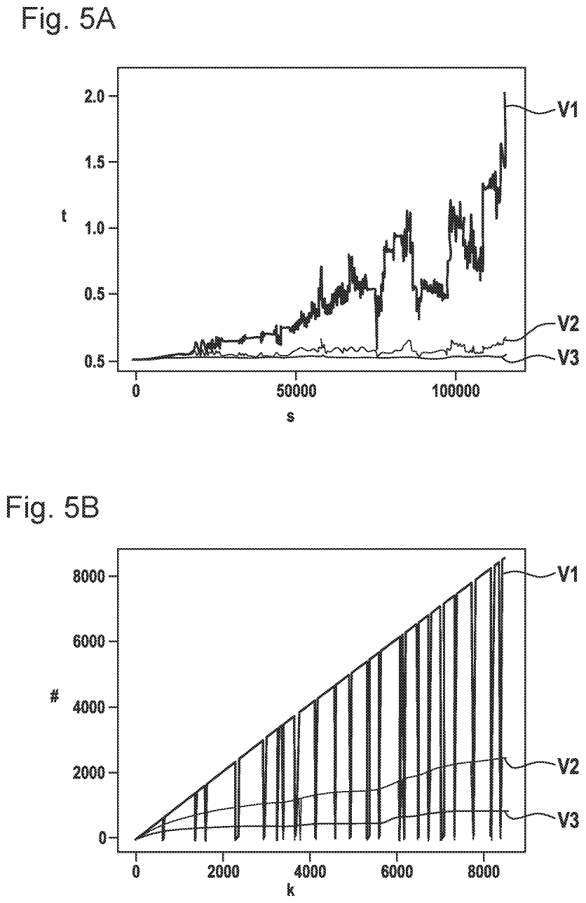

FIGS. 5A and 5B show the same comparison for a different, and specifically larger, environment; in this case, the impact of the present invention is even more clearly visible.

1-19. (Canceled).

20. A method for thinning a SLAM graph, which is used for operating a mobile device and has a multiplicity of nodes and a multiplicity of edges, each of the edges ending with an end point at a node, the method comprising the following steps:
obtaining the SLAM graph;
removing nodes from the SLAM graph; and
outputting an updated SLAM graph;
wherein, for each node removed from SLAM graph, the removing includes:
determining, out of the multiplicity of nodes, the node whose scale-invariant density at further nodes around the node is the highest, and
removing the determined node whose density is the highest from the SLAM graph.

21. The method as recited in claim 20, wherein the removing of the determined node whose density is the highest from the SLAM graph includes: linking an end point, which is then unconnected, of an edge that ended at the removed node to another node.

22. The method as recited in claim 21, wherein, out of the nodes adjacent to the removed node, the node to which the unconnected end point is linked is selected by moving the end point forward or backward along a movement chain made up of movement edges until another node is reached, wherein the node at which a length of the newly produced edge is shortest is selected as the node to which the unconnected end point is linked.

23. The method as recited in claim 21, wherein, when two edges are combined when linking the end point of an edge to another node, a loop-closure edge is removed when it contradicts a movement edge, and/or, when both of the two edges are loop-closure edges, both are removed when they contradict each other.

24. The method as recited in claim 20, wherein the scale-invariant density for each node is a measure of simple densities determined over various radii, wherein a simple density is in each case a density at further nodes within a particular radius around the node.

25. The method as recited in claim 20, wherein as many nodes are removed from the SLAM graph as are needed until the scale-invariant density is below a density threshold at all the nodes and/or until a quantity of nodes in the SLAM graph is below a node threshold, wherein the node threshold is predetermined based on a geometric size of an environment represented by the SLAM graph.

26. The method as recited in claim 20, wherein a predetermined quantity of nodes most recently added to the SLAM graph are not taken into account when removing nodes.

27. The method as recited in claim 20, wherein, independently of any removal of a node, edges are removed from the SLAM graph, wherein removing an edge in each case includes:
determining, out of the multiplicity of nodes, the node at which the most edges end;
determining, from the edges that end at the determined node at which the most edges end, the edge that has the greatest covariance or the least amount of information; and
removing the determined edge.

28. The method as recited in claim 27, wherein the determined edge is removed only when it is a loop-closure edge.

29. The method as recited in claim 27, wherein the determined edge is removed only when a factor, which indicates a ratio of a length of a shortest path, not containing the edge, between two nodes at which the edge ends to a length of the edge, is below a factor threshold.

30. The method as recited in claim 27, wherein, independently of any removal of a node, as many edges are removed from the SLAM graph as are needed until a quantity of edges that end at the same node is below an edge threshold at all the nodes.

31. A method for operating a mobile device, comprising the following steps:
obtaining environment information captured using one or more sensors;
determining a current position and/or orientation of the mobile device based on a current SLAM graph and the environment information;
determining control instructions for operating the mobile device based on the current position and/or orientation; and
implementing the control instructions by the mobile device;
wherein: i) an older SLAM graph that has been thinned is used as the current SLAM graph, and/or ii) the current SLAM graph is expanded using the environment information and is then thinned for later use as a current SLAM graph;
wherein the thinning of a SLAM graph of the older SLAM graph or the current SLAM graph includes:
removing nodes from the SLAM graph, and
outputting an updated SLAM graph,
wherein, for each node removed from SLAM graph, the removing includes:
determining, out of the multiplicity of nodes, the node whose scale-invariant density at further nodes around the node is the highest, and
removing the determined node whose density is the highest from the SLAM graph.

32. The method as recited in claim 31, wherein the mobile device is a robot.

33. The method as recited in claim 31, wherein the mobile device is: i) a domestic robot including a robot vacuum cleaner and/or a robot mop, or ii) a floor or street cleaning device, or iii) a robot lawnmower, or iv) an at least partly automated vehicle, or v) a drone.

34. The method as recited in claim 31, wherein the one or more sensors selected from: video cameras, radar sensors, LiDAR sensors, laser rangefinders, ultrasonic sensors, inertial sensors, odometers.

35. An arithmetic logic unit configured to thin a SLAM graph, which is used for operating a mobile device and has a multiplicity of nodes and a multiplicity of edges, each of the edges ending with an end point at a node, the arithmetic logic unit being configured to:
obtain the SLAM graph;
remove nodes from the SLAM graph; and
output an updated SLAM graph;
wherein, for each node removed from SLAM graph, the removing includes:
determining, out of the multiplicity of nodes, the node whose scale-invariant density at further nodes around the node is the highest, and
removing the determined node whose density is the highest from the SLAM graph.

36. A mobile device, comprising:
at least one sensor configured to capturing environment information; and
an arithmetic logic unit configured to operate the mobile device, the arithmetic logic unit configured to:
obtain environment information captured using one or more sensors;
determine a current position and/or orientation of the mobile device based on a current SLAM graph and the environment information;
determine control instructions for operating the mobile device based on the current position and/or orientation; and
implement the control instructions by the mobile device;
wherein: i) an older SLAM graph that has been thinned is used as the current SLAM graph, and/or ii) the current SLAM graph is expanded using the environment information and is then thinned for later use as a current SLAM graph;
wherein the arithmetic logic unit is configured to thin a SLAM graph of the older SLAM graph or the current SLAM graph by:
removing nodes from the SLAM graph, and
outputting an updated SLAM graph,
wherein, for each node removed from SLAM graph, the removing includes:
determining, out of the multiplicity of nodes, the node whose scale-invariant density at further nodes around the node is the highest, and
removing the determined node whose density is the highest from the SLAM graph.

37. The mobile device as recited in claim 36, wherein the mobile device is: i) a domestic robot including a robot vacuum cleaner and/or a robot mop, or ii) a floor or street cleaning device, or iii) a robot lawnmower, or iv) an at least partly automated vehicle, or v) a drone.

38. A non-transitory machine-readable storage medium on which is stored a computer program for thinning a SLAM graph, which is used for operating a mobile device and has a multiplicity of nodes and a multiplicity of edges, each of the edges ending with an end point at a node, the computer program, when executed by an arithmetic logic unit, causing the arithmetic logic unit to perform the following steps:
obtaining the SLAM graph;
removing nodes from the SLAM graph; and
outputting an updated SLAM graph;
wherein, for each node removed from SLAM graph, the removing includes:
determining, out of the multiplicity of nodes, the node whose scale-invariant density at further nodes around the node is the highest, and
removing the determined node whose density is the highest from the SLAM graph.
